(19) United States
(12) Patent Application Publication
(10) Pub. No.: US 2014/0173365 A1
(43) Pub. Date: Jun. 19, 2014

(54) SEMICONDUCTOR APPARATUS, MANAGEMENT APPARATUS, AND DATA PROCESSING APPARATUS

(71) Applicant: FUJITSU LIMITED, Kawasaki-shi (JP)

(72) Inventors: Shintaro ITOZAWA, Kawasaki (JP); Jin TAKAHASHI, Bunkyo (JP)

(73) Assignee: FUJITSU LIMITED, Kawasaki-shi (JP)

(21) Appl. No.: 14/184,749

(22) Filed: Feb. 20, 2014

Related U.S. Application Data
(63) Continuation of application No. PCT/JP2011/069221, filed on Aug. 25, 2011.

(51) Int. Cl. G06F 13/24; G06F 11/07

(52) U.S. Cl. CPC G06F 13/24; G06F 11/0793
USPC 714/48; 710/260

(57) ABSTRACT

A system to which the present application is applied includes a semiconductor apparatus including: a first communication unit which communicates with a central processing unit; a second communication unit which communicates with another data processing apparatus through a slot connectable to the central processing unit; and an interruption notification unit which notifies a management apparatus of an interruption from the central processing unit. As a result, when the semiconductor apparatus is applied to a system without a communication function for communicating with another data processing apparatus, the semiconductor apparatus enables the connection to the other data processing apparatus.

### CROSS-REFERENCE TO RELATED APPLICATION

This application is a continuation application of International Application PCT/JP2011/069221 filed on Aug. 25, 2011 and designated the U.S., the entire contents of which are incorporated herein by reference.

### FIELD

The embodiments discussed herein are related to a technology for realizing a resource expansion of a data processing apparatus such as a computer.

### BACKGROUND

In recent years, a scale-up type computer which can expand a resource (a data processing apparatus) has been widely used for a server. In the scale-up type computer, components needed for a computer are gathered into one apparatus (hereinafter referred to as a “module device), and one or more module devices are implemented on the computer. As the module device, an apparatus on which a CPU (Central Processing Unit) and a memory are mounted (hereinafter referred to as a “system board” or “SB”) or an apparatus on which a hard disk device and an IO (Input Output) device such as a PCI (Peripheral Components Interconnect bus) slot are mounted (hereinafter referred to as an “IO unit”), are provided.

FIG. 1 illustrates a configuration of a scale-up type computer.

A computer illustrated in FIG. 1 implements a plurality of system boards 1 on which two CPUs 11 (11-1 and 11-2) are mounted. Each of the system boards 1 is connected to a signal transmission line 2 such as a crossbar, and a signal (in FIG. 1, referred to as an “inter-SB transmission signal”) is transmitted/received between the system boards through the signal transmission line 2. As a result of this configuration, a resource expansion, i.e., a scaling up, can be performed by adding a module device which will be connected to the signal transmission line 2. Therefore, as an example, when three system boards 1-1 to 1-3 have an insufficient processing capacity, another system board 1 may merely be connected to the signal transmission line 2. When an IO device is increased, an IO unit not illustrated may merely be connected to the signal transmission line 2. As described above, the module device, i.e., the system board 1 or the IO unit, is a unit for an addition of a resource.

Each of the system boards 1 includes an FWH (Firmware Hub) 12, a memory module (in FIG. 1, referred to as “DIMM” (Dual Inline Memory Module)) 13, a memory controller (MC) 14, an ICH (I/O Controller Hub) 15, an IO slot 16, and a BMC (Baseboard Management Controller) 17, in addition to the two CPUs 11 (11-1 and 11-2).

The FWH 12 is a memory which stores a BIOS (Basic Input/Output System) code. This BIOS code is read and executed by the CPU 11-1 connected to the FWH 12. The BIOS code read by the CPU 11-1 is output to the CPU 11-2. Therefore, the CPU 11-2 also executes the BIOS code stored in the FWH 12.

The ICH 15 includes various types of controllers, for example, and transmits/receives data to/from a device which is inserted into and connected to the IO slot 16. In FIG. 1, as the device connected to (inserted into) the IO slot 16, a PCI express (Exp) card 18 is illustrated.

The two CPUs 11, the signal transmission line 2, the memory module 13, the ICH 15, and the BMC 17 are connected to the MC 14. The MC 14 accesses the memory module 13, and also transmits/receives a signal to/from another system board 1 through the signal transmission line 2 and to/from the ICH 15. The MC 14 notifies the BMC 17 of an error and an interruption. Hereinafter, a signal for the interruption notification is referred to as an “AS (Active Status) signal”. The error notification is performed in response to an occurrence of a hardware error. Due to the transmission/reception of a signal to/from other system boards 1 through the signal transmission line 2, a plurality of CPUs 11 on the system board 1 can share one memory module 13 on the system board 1.

The AS signal is output from the MC 14 to the BMC 17 in response to a request from the CPU 11. Each of the CPUs 11 and the MC 14 notify the BMC 17 of an error in response to the occurrence of the hardware error.

Each of the CPUs 11 and the MC 14 include a register, not particularly illustrated, which stores data indicating the details of the error. When each of the CPUs 11 and the MC 14 notify the BMC 17 of the error, they make the registers included in themselves store the data indicating the details of the error. Then, when an error notification has been issued from any of the CPUs 11 or the MC 14, the BMC 17 reads the data in the register of the CPU 11 or the MC 14 which issued the error notification. The communication between the MC 14 and the BMC 17 for accessing the register is directly performed using an I2C (Inter-Integrated Circuit), for example. The communication between each of the CPUs 11 and the BMC 17 is performed through the ICH 15 and the MC 14.

The BMC 17 is a management apparatus which manages the system board 1. The BMC 17 constantly monitors the error notification from each of the CPUs 11 and the MC 14, issues the error notification to an MMB (ManageMent Board) 4, reads the data stored in the register of the MC 14 in response to the error notification, and transmits the data to the MMB4. Further, the BMC 17 constantly monitors the AS signal output from the MC 14, and issues an interruption notification by the AS signal to the MMB 4. The BMC 17 on each of the system boards 1 and the MMB 4 are connected through a signal transmission line 3.

The MMB 4 is an apparatus which performs control, monitoring, and various types of management of the entirety of a computer system. Partition management, system initiation, etc., are performed under the control of the MMB 4. The MMB 4 communicates with the CPU 11 on the system board 1 through the BMC 17, the ICH 15, and the MC 14, gathers information of each of the system boards 1, and manages operation of the entirety of the computer system.

The information of each of the system boards 1 is gathered in response to the output of the AS signal from each of the CPUs 11. Therefore, when each of the CPUs 11 on each of the system boards 1 reports a configuration of the memory module 13 or a configuration of itself, or when an event occurs, each of the CPUs 11 makes the BMC 17 output the AS signal through the MC 14. The insertion and detachment of the PCI Exp card 18 into/from the IO slot 16 respectively correspond to the occurrence of the event.

Each of the CPUs 11 includes a register which reports the configuration of the memory module 13, the configuration of itself, or the event. When each of the CPUs 11 makes the MC 14 output the AS signal, it stores data to be reported to the MMB 4 in the register. The data stored in the register is transmitted to the MMB 4 through the BMC 17, the ICH 15, and the MC 14. The register is, for example, a register used for storing the data indicating the details of the error. Namely, the data to be reported to the MMB 4 and the data indicating the details of the error may be stored in the same register.

On the system board 1 used for the scale-up type computer, as described above, a communication function (the MC 14) which communicates with other system boards 1 is mounted, assuming a scaling up. However, one system board is sufficient for some users. Assuming such users, an inexpensive system board on which no communication functions are mounted has been commercialized.

FIG. 2 illustrates a configuration of a system board on which no communication functions are mounted. In FIG. 2, the same or basically the same components as those in FIG. 1 are denoted by the same references. Therefore, focusing on the differences from FIG. 1, the configuration of the system board 1′ on which no communication functions are mounted is described below.

In the system board 1′ illustrated in FIG. 2, a communication function with the system board 1 as illustrated in FIG. 1 is omitted by not mounting the MC 14. As the MC 14 is not mounted, a memory module 13 is connected to each of the CPUs 11. Further, a BMC 17 is connected to each of the CPUs 11, an ICH 15 is also connected to a CPU 11-1, and an IO slot 19 is also connected to a CPU 11-2.

Each of the CPUs 11-1 and 11-2 includes a register accessible from the BMC 17. This register is used for storing data indicating the details of an error. When an error is reported from either of the CPUs 11, the BMC 17 reads data from the register of the CPU 11 which reported the error.

A user sometimes expands a resource of a computer as a result of an increase in data processing amount resulting from a business expansion, etc. In the system board 1 as illustrated in FIG. 1, the resource can be expanded by newly connecting a module device, which is a unit for an addition of a resource, that is, the system board 1 or the IO unit. However, the system board 1′ as illustrated in FIG. 2 cannot be connected to another system board 1 or 1′, or to the IO unit, as a communication function is omitted.

When a user hopes to expand a resource of a computer, the user sometimes hopes to continue to use the current system board 1′ in order to suppress the cost for the expansion.

Patent Document 1: Japanese Laid-open Patent Publication No. 8-272736

Patent Document 2: Japanese Laid-open Patent Publication No. 6-168188

Patent Document 3: Japanese Laid-open Patent Publication No. 4-199332

### SUMMARY

A system to which the present invention is applied includes a semiconductor apparatus including: a first communication unit which communicates with a central processing unit; a second communication unit which communicates with another data processing apparatus through a slot connectable to the central processing unit; and an interruption notification unit which notifies a management apparatus of an interruption from the central processing unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration of a scale-up type computer;

FIG. 2 illustrates an example of a configuration of a system board on which a communication function is not mounted;

FIG. 3 illustrates an example of a configuration of a computer (a data processing apparatus) according to an embodiment;

FIG. 4A is a diagram illustrating more detailed configurations of a CPU, a BMC, and an MC;

FIG. 4B is another diagram illustrating the more detailed configurations of the CPU, the BMC, and the MC;

FIG. 4C is another diagram illustrating the more detailed configurations of the CPU, the BMC, and the MC;

FIG. 5A is a flowchart illustrating an example of a flow of the operations of the CPU, the MC and the BMC;

FIG. 5B is another flowchart illustrating the example of the flow of the operations of the CPU, the MC and the BMC; and

FIG. 5C is another flowchart illustrating the example of the flow of the operations of the CPU, the MC and the BMC.

### DESCRIPTION OF EMBODIMENTS

A technology to which the present invention is applied aims at enabling the expansion of a resource using a module device without a communication function with other module devices.

An embodiment of the present application is described below in detail with reference to the drawings.

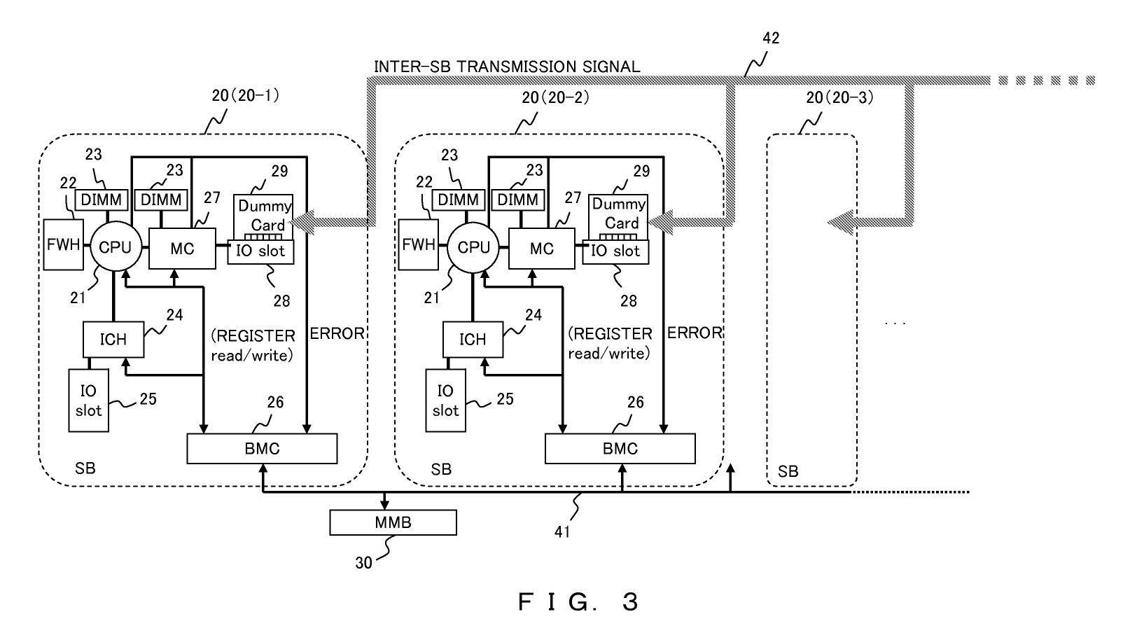

FIG. 3 illustrates an example of a configuration of a computer (a data processing apparatus) according to this embodiment. As illustrated in FIG. 3, a computer includes a plurality of system boards 20 (20-1 to 20-3, etc.) and an MMB 30. The MMB (ManageMent Board) 30 is an apparatus which performs the control, monitoring, and various types of management of the entirety of a computer system, and is connected to each of the system boards 20 through a signal transmission line 41. Each of the system boards 20 is a module device which functions as one computer, and the system boards 20 are connected to each other through a signal transmission line 42.

As illustrated in FIG. 3, each of the system boards 20 includes a CPU 21, an FWH (Firm Ware Hub) 22, a memory module (in FIG. 3, referred to as “DIMM” (Dual Inline Memory Module)) 23, an ICH (I/O Controller Hub) 24, IO slots 25 and 28, a BMC (Baseboard Management Controller) 26, and a memory controller (MC) 27.

The FWH 22 is a memory which stores a BIOS (Basic Input/Output System) code. This BIOS code is read and executed by the CPU 21 connected to the FWH 22. The memory module 23 is also connected to the CPU 21.

The ICH 24 includes, for example, various types of controllers, and is connected to the CPU 21, the IO slot 25, and the BMC 26. The ICH 24 transmits/receives data to/from a device which is inserted into and connected to the IO slot 25.

The CPU 21, the memory module 23, the BMC 26, and the IO slot 28 are connected to the MC 27. The MC 27 accesses the memory module 23. Further, the MC 27 enables the communication with module devices, e.g., other system boards 20, using the IO slot 28, and outputs an AS (Active Status) signal for an interruption notification in response to a request from the CPU 21. The communication with the module devices, e.g., the other system boards 20, is performed through the signal transmission line 42.

The MC 27 includes a register for storing data indicating the details of an error (hereinafter referred to as “error detail data”). The CPU 21 includes a register for storing the error detail data to be transmitted to the MMB 30. The BMC 26 is a management apparatus which manages the system board 20. The BMC 26 constantly monitors an error notification from the CPU 21 and the MC 27, issues the error notification to the MMB 30, reads data stored in the register of the CPU 21 or the MC 27, and transmits the data to the MMB 30. Further, the BMC 26 constantly monitors the AS signal output from the MC 27, and issues an interruption notification by the AS signal to the MMB 30. The BMC 26 of each of the system boards 20 and the MMB 30 are connected through the signal transmission line 41.

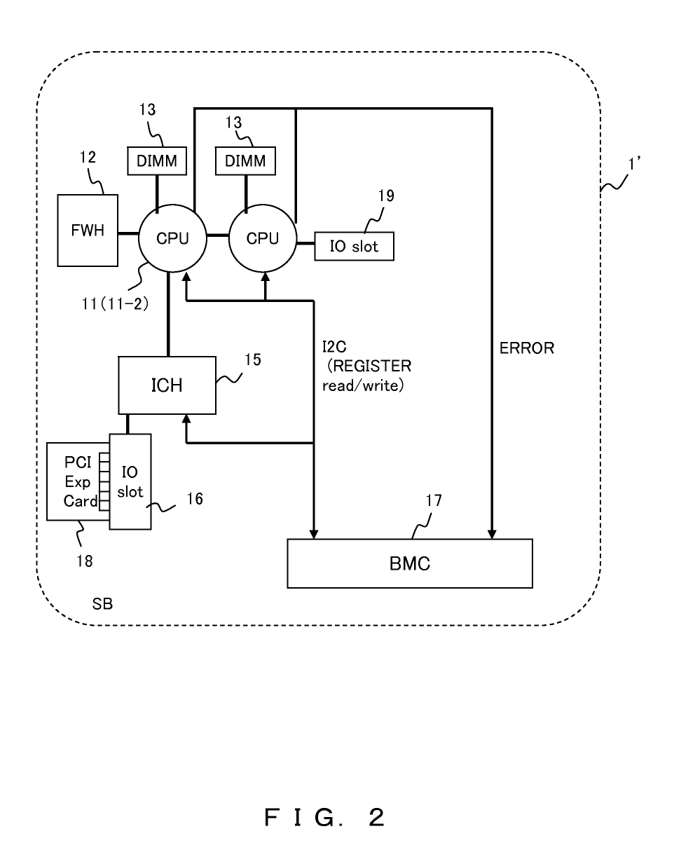

As described above, each of the system boards 20 in this embodiment includes the CPU 21, the FWH 22, the memory module 23, the ICH 24, the IO slots 25 and 28, and the BMC 26. Therefore, each of the system boards 20 is configured so that the CPU 11-2 on the system board 1′ as illustrated in FIG. 2 is replaced with the MC 27.

The configurations of the CPU 21, the FWH 22, the memory module 23, the ICH 24, and the IO slots 25 and 28 on each of the system boards 20 are basically the same as those of the CPU 11, the FWH 12, the memory module 13, the ICH 15, and the IO slots 16 and 19 as illustrated in FIG. 2, respectively. Therefore, the MC 27 and the BMC 26 are focused on and described below.

The MC 27 is a semiconductor apparatus that is assumed to be mounted on the system board instead of the CPU 11-2 in order to realize resource expansion. The MC, instead of the CPU 11-2, is mounted on the system board because a socket, etc., for newly mounting a semiconductor apparatus such as the MC 27, is not provided on a Printed Circuit Board (PCB) used for the system board 1′ as illustrated in FIG. 2 (corresponding to one computer). Therefore, the MC 27 has socket compatibility with the CPU 21 (the CPU 11). As a result, the MC 27 can be attached to a socket to which the CPU 21 can be attached. The MC 27 is realized so as to transmit/receive necessary signals through a plurality of pins not illustrated when the MC 27 is connected to a socket to which the CPU is assumed to be attachable. By providing the MC 27 as described above, a module device such as the system board 1′ in FIG. 2 can continue to be used even when the resource is expanded.

The signal transmission line 42 is connected to a dummy card 29 inserted into the IO slot 28 of each of the system boards 20. On the printed circuit board used for the system board 1′ as illustrated in FIG. 2, a socket, etc., for connecting to the signal transmission line 42 is not provided. In view of this, in this embodiment, the dummy card 29 is provided in order to connect it to the signal transmission line 42, and the MC 27 is configured to transmit/receive a signal (in FIG. 3, referred to as an “inter-SB transmission signal”) to/from the signal transmission line 42.

In the system board 1′ as illustrated in FIG. 2, an error notification can be issued from each of the CPUs 11 to the BMC 17. However, the system board 1′ as illustrated in FIG. 2 does not assume to be connected to another module device, and therefore it cannot transmit/receive an AS signal. In view of this, in this embodiment, a configuration as described below enables the output of the AS signal from the MC 27 to the BMC 26.

In the system board 1′ as illustrated in FIG. 2, the error notification from each of the CPUs 11 to the BMC 17 is issued by transmitting/receiving an error signal through a different signal line for each of the expected error levels. In view of this, in this embodiment, one signal line or a pair of signal lines from among a plurality of signal lines are allocated for error notifications at a plurality of error levels, and one signal line or a pair of signal lines which have not been allocated are used for the output of the AS signal. As a result, even in the system board 1′ as illustrated in FIG. 2, the error signal and the AS signal can be output from the MC 27 replacing the CPU.

The BMC 26 can access the registers of the CPU 21 and the MC 27. The error signal is an output signal from a register (an error recording register) having bits of the number of error levels, for example. Similarly, the AS signal is an output signal from a register (an AS factor register) having bits of the number of interruption factors, for example. The MC 27 includes the error recording register and the AS factor register, and the BMC 26 can access the error recording register and the AS factor register of the MC 27 through another signal line which is not used for the error notification (for example, the I2C). Therefore, even when some signal lines for the error notification are used for an interruption notification, the BMC 26 can appropriately recognize the error signal and the AS signal from the MC 27 by accessing the error recording register or the AS factor register of the MC 27. As a result, the BMC 26 can obtain configuration data or error detail data from the CPU 21, and can obtain error detail data from the MC 27.

The configuration data and the error detail data which the BMC 26 obtained are transmitted from the BMC 26 through the signal transmission line 41 to the MMB 30. Therefore, the MMB 30 can perform the control that reflects the configuration data and the error detail data obtained through the BMC 26. The MMB 30 recognizes a configuration of the memory module 23 or a configuration of the CPU 21, or an event that occurred on the system board 20, and performs the control, monitoring, and various kinds of management of the entirety of a computer system including the plurality of system boards 20.

As a result of the above, the CPU 11 (the CPU 21) on the system board 1′ as illustrated in FIG. 2 and the socket-compatible MC 27 realize the resource expansion, i.e., the connection of another module device to an existing module device such as the system board 1′. Therefore, a user's desire to expand the resource while continuing to use the existing module device can be met by providing a semiconductor apparatus such as the MC 27.

Further, the MC 27 includes a function of outputting the error signal and the AS signal, and the BMC 26 constantly monitors the error signal and the AS signal and realizes a data transfer between the CPU 21 or the MC 27 and the MMB 30. As a result of this, the MMB 30 can manage the entirety of the system after the resource expansion. As will be described below in detail, the BMC 26 processes only the error signal from the CPU 21 when the MC 27 is not connected. Therefore, the BMC 26 can be mounted on the system board 1′ as illustrated in FIG. 2. As a result, when the BMC 26 is mounted instead of the BMC 17 on the system board 1′ as illustrated in FIG. 2, a resource expansion in which another module device is added can be coped with by replacing the CPU 11-2 with the MC 27.

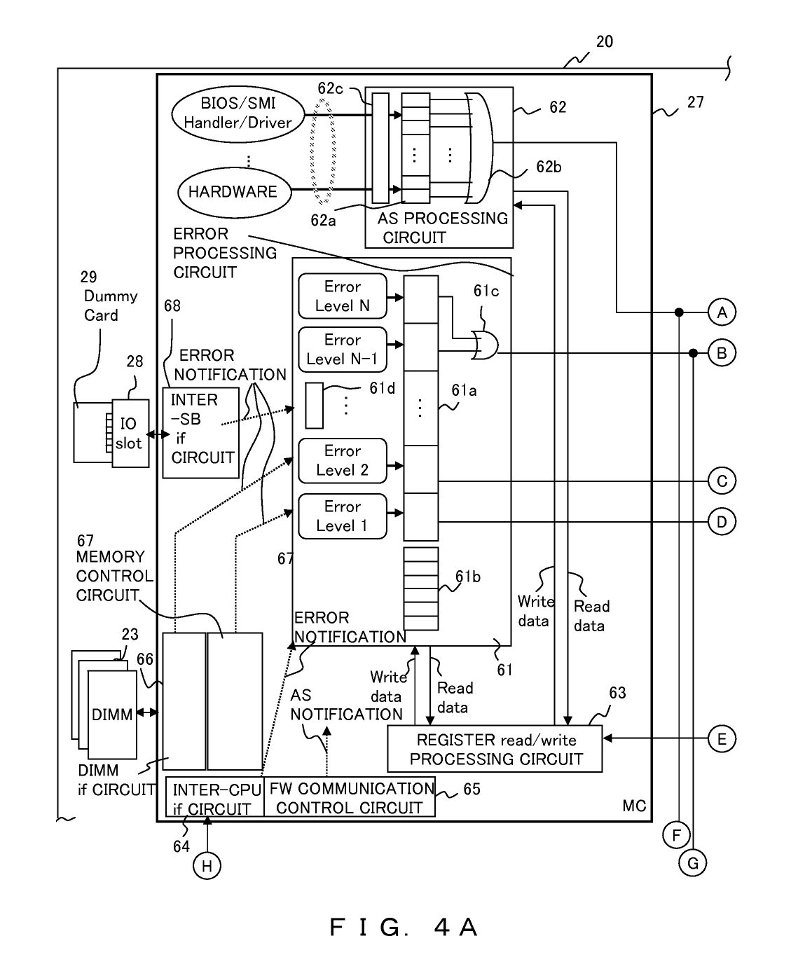

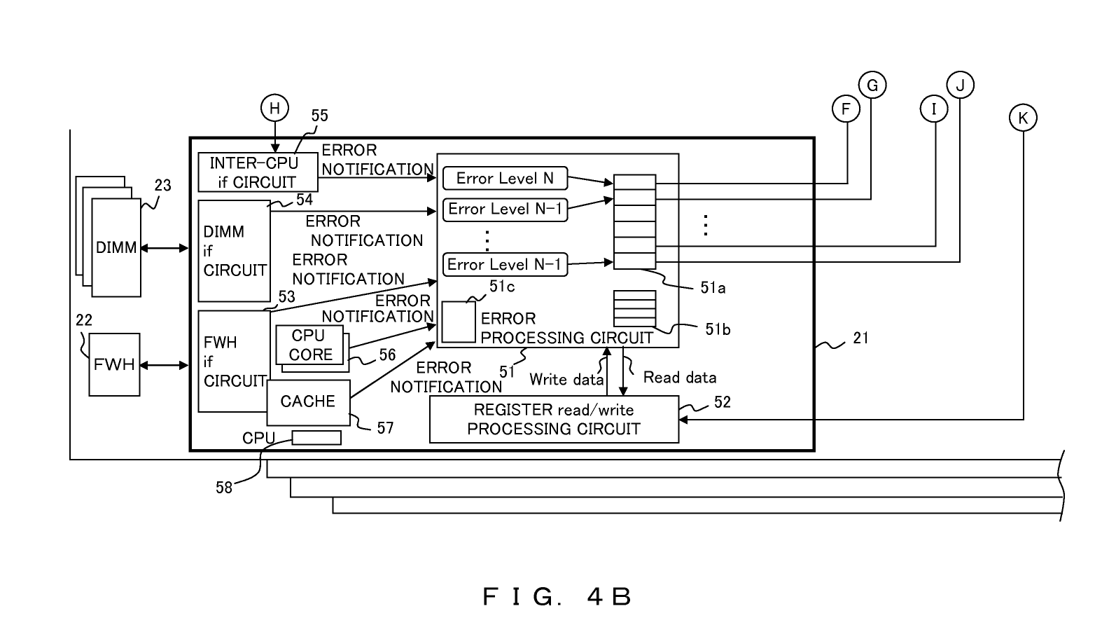

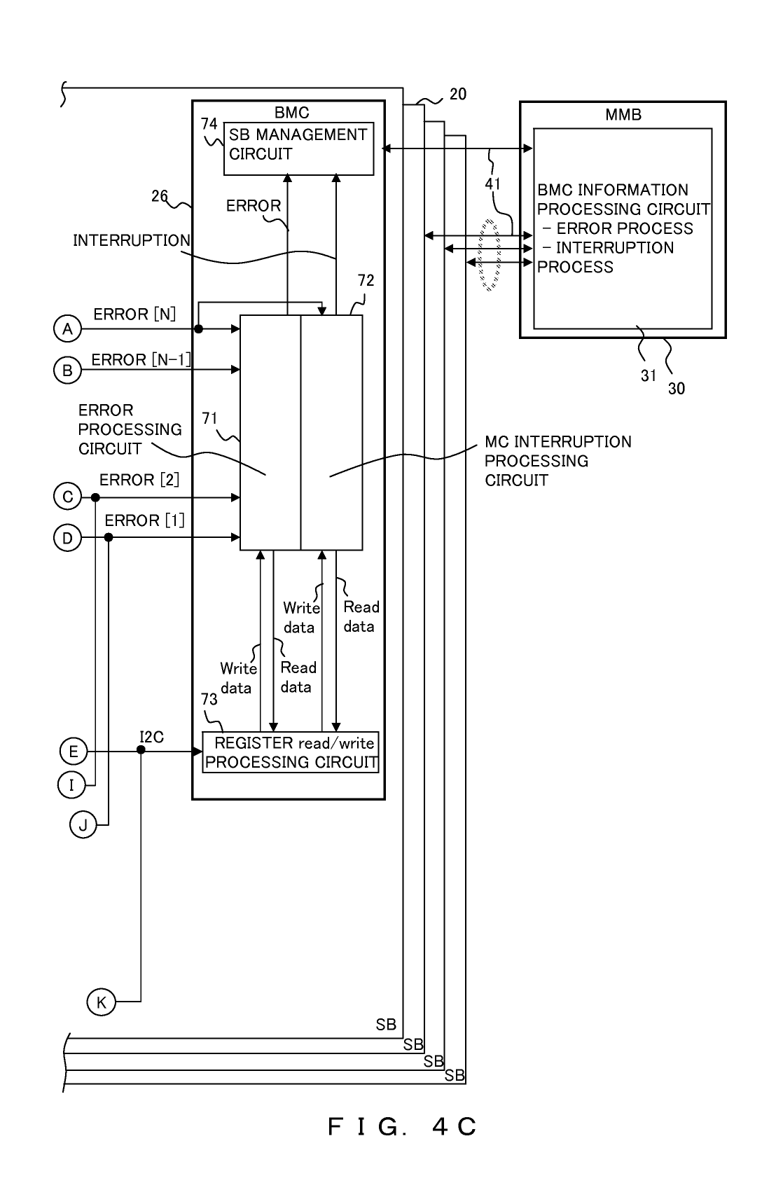

FIG. 4A to FIG. 4C illustrate detailed configurations of the CPU, the BMC and the MC. With reference to FIG. 4A to FIG. 4C, the detailed configurations of the CPU 21, the BMC 26, and the MC 27, and the operations thereof, are described next.

As illustrated in FIG. 4B, the CPU 21 includes an error processing circuit 51, a register read/write processing circuit 52, an FWH if (interface) circuit 53, a DIMM if circuit 54, an inter-CPU if circuit 55, a plurality of CPU cores 56, a cache memory 57, and a configuration recording register 58.

The FWH if circuit 53 of the CPU 21 reads a BIOS code stored in the FWH 22, and supplies it to each of the CPU cores 56. The DIMM if circuit 54 is a circuit used for accessing the memory module 23. The inter-CPU if circuit 55 is a circuit used for communicating with another CPU 21 or the MC 27. The plurality of CPU cores 56 perform processing using data stored in the cache memory 57.

The error processing circuit 51 of the CPU 21 is a circuit used for the output, etc., of the error signal to the BMC 26. The error processing circuit 51 includes an error recording register 51a having at least the same number of bits as the number of error levels, an error details recording register 51b storing error detail data, and a write processing circuit 51c.

Different error levels from 1 to N are respectively allocated to bits of the error recording register 51a, and a value of each of the bits is output to the BMC 26 as an error signal at a corresponding error level (in FIG. 4C, referred to as “ERROR[1]” to “ERROR[N]”). As an example, the value of each of the bits, i.e., the error signal at each of the error levels, is asserted when it is 1, and it is negated when it is 0.

All of the FWH if circuit 53, the DIMM if circuit 54, the inter-CPU if circuit 55, the plurality of CPU cores 56, and the cache memory 57 include a function of detecting an error and notifying the error processing circuit 51 of the detected error. The write processing circuit 51c rewrites a 1-bit value in the error recording register 51a to 1, in response to the error notification from, for example, the FWH if circuit 53, the DIMM if circuit 54, the inter-CPU if circuit 55, one of the plurality of CPU cores 56, or the cache memory 57. The write processing circuit 51c specifies an error level in accordance with, for example, a component that issued the error notification and the contents of the error notification, and writes error detail data in the error details recording register 51b.

The configuration recording register 58 is used for storing data to be transmitted to the MMB 30 other than the error detail data (hereinafter referred to as “configuration data”).

As will be described later, the AS signal is output from the MC 27 under the control of the CPU core 56. A program causing the CPU core 56 to control the output of the AS signal is, for example, a BIOS code, an SMI handler (System Management Interrupt Handler), or various types of drivers. The SMI handler is a program that is called and executed for processing a corresponding event. The configuration data stored in the configuration recording register 58 is read by the BMC 26 if needed when the AS signal has been output from the MC 27.

The register read/write processing circuit 52 accesses the error recording register 51a or the error details recording register 51b in response to a request from the BMC 26. The BMC 26 can obtain data stored in each of the error recording register 51a and the error details recording register 51b through the register read/write processing circuit 52.

As illustrated in FIG. 4A, the MC 27 includes an error processing circuit 61, an AS processing circuit 62, a register read/write processing circuit 63, an inter-CPU if circuit 64, an FW (Firm Ware) communication control circuit 65, a DIMM if circuit 66, a memory control circuit 67, and an inter-SB if circuit 68.

The inter-CPU if circuit 64 is a circuit used for communicating with the CPU 21. The FW communication control circuit 65 is a circuit which processes a request received from the CPU 21 through the inter-CPU if circuit 64. When the inter-CPU if circuit 64 receives a request for the output of the AS signal from the CPU 21, the FW communication control circuit 65 processes the output request, and issues an AS notification causing the AS processing circuit 62 to output the AS signal. This AS notification specifies a factor issuing an interruption notification.

The DIMM if circuit 66 is a circuit used for accessing the memory module 23. The memory control circuit 67 controls an access to the memory module 23 through the DIMM if circuit 66. The inter-SB if circuit 68 realizes the communication with a module device including another system board 20 through the dummy card 29 and the IO slot 28.

The error processing circuit 61 is a circuit used for the output of an error signal to the BMC 26. Similarly to the error processing circuit 51 of the CPU 21 as described above, the error processing circuit 61 includes an error recording register 61a having at least the same number of bits as the number of error levels, an error details recording register 61b storing error detail data, an OR gate 61c, and a write processing circuit 61d.

Different error levels are respectively allocated to bits of the error recording register 61a, and a value of each of the bits is output to the BMC 26 as an error signal at a corresponding error level (in FIG. 4C, referred to as “ERROR [1]” to “ERROR [N]”). As an example, the value of each of the bits, i.e., the error signal at each of the error levels, is asserted when it is 1, and it is negated when it is 0, as described above.

All of the inter-CPU if circuit 64, the DIMM if circuit 66, the memory control circuit 67, and the inter-SB if circuit 68 have a function of detecting an error and notifying the error processing circuit 61 of the detected error. The write processing circuit 61d rewrites a 1-bit value in the error recording register 61a to 1, in response to an error notification from, for example, the inter-CPU if circuit 64, the DIMM if circuit 66, the memory control circuit 67, or the inter-SB if circuit 68. Further, the write processing circuit 61d specifies an error level in accordance with, for example, a component that issued the error notification and the contents of the error notification, and writes error detail data to the error details recording register 51b.

An error signal at the error level N−1 and an error signal at the error level N are ORed by the OR gate 61c, and the OR output from the OR gate 61c is output to the BMC 26 as an error signal at the error level N−1. Then, the error signal at the error level N−1, which the BMC 26 receives, is asserted when either of the error signals at the error levels N−1 and N is asserted. Therefore, the BMC 26 can recognize from the error signal at the error level N−1 that either of the error signals at the error levels N−1 and N was asserted. There may be two or more error signals (signal lines) which are ORed by the OR gate 61c, and therefore the number of error signals (signal lines) is not limited to two.

The AS processing circuit 62 is a circuit used for the output of the AS signal to the BMC 26. The AS processing circuit 62 includes an AS factor register 62a having the same number of bits as the number of interruption factors, an OR gate 62b, and a write processing circuit 62c.

Different interruption factors are respectively allocated to bits of the AS factor register 62a, and a value of each of the bits corresponds to an AS signal of a corresponding interruption factor. As an example, the value of each of the bits, i.e., the AS signal of each of the interruption factors, is asserted when it is 1, and it is negated when it is 0. The write processing circuit 62c rewrites a 1-bit value in the AS factor register 62a to 1, in response to an AS notification from the FW communication control circuit 65. In FIG. 4A, a BIOS code, an SMI handler, and a driver are illustrated as a program causing the CPU core 56 of the CPU 21 to issue the AS notification. A piece of hardware issues the AS notification via, for example, the SMI handler.

The value of each of the bits of the AS factor register 62a is output to the OR gate 62b. The OR gate 62b ORs all of the bit values of the AS factor register 62a, and outputs the OR. The OR output from the OR gate 62b is output to the BMC 26 as an error signal at the error level N. The OR output from the OR gate 62b is an OR of AS signals of all of the interruption factors, and therefore it is referred to as an “AS OR signal”.

The register read/write processing circuit 63 accesses the error recording register 61a or the error details recording register 61b of the error processing circuit 61, or the AS factor register 62a of the AS processing circuit 62, in response to a request from the BMC 26. The BMC 26 can obtain data stored in each of the error recording register 61a and the error details recording register 61b of the error processing circuit 61 and the AS factor register 62a of the AS processing circuit 62, through the register read/write processing circuit 63.

As illustrated in FIG. 4C, the BMC 26 includes an error processing circuit 71, an MC interruption processing circuit 72, a register read/write processing circuit 73, and an SB management circuit 74. The MMC 30 includes a BMC information processing circuit 31.

The error processing circuit 71 of the BMC 26 is a processing circuit used for constantly monitoring an error notification and handling the interruption notification. The MC interruption processing circuit 72 is a processing circuit used for constantly monitoring an interruption notification by the AS signal and handling the interruption notification. The register read/write processing circuit 73 is a circuit used for reading data from the CPU 21 or the MC 27. The SB management circuit 74 constantly monitors an error occurrence and an interruption notification, and notifies the MMB 30 of the error occurrence and the interruption notification.

As illustrated in FIG. 4A to FIG. 4C, error signals at the error levels 1 to N−1 output from the error processing circuit 51 of the CPU 21 are input to the BMC 26 through the same signal line as the signal line through which the error signals at the error levels 1 to N−1 are output from the error processing circuit 61 of the MC 27. The error signal at the error level N output from the error processing circuit 51 of the CPU 21 is input to the BMC 26 through the same signal line as the signal line through which the AS OR signal is output from the AS processing circuit 62 of the MC 27 as the error signal at the error level N. Therefore, the BMC 26 is unable to specify an output destination of the error signal regardless of the error level. In view of this, the BMC 26 accesses the CPU 21 and the MC 27 as described below in accordance with an error level of an asserted error signal.

When the error level of the asserted error signal is within the range of 1 to N−1, the BMC 26 obtains data of each of the registers 51a and 51b of the error processing circuit 51 of the CPU 21 and the registers 61a and 61b of the error processing circuit 61 of the MC 27. Then, the BMC 26 specifies the output destination of the asserted error signal, and obtains error detail data from the output destination. The data is obtained by the control of the register read/write processing circuit 73 by the error processing circuit 71. The error processing circuit 71 outputs the error detail data obtained from the specified output destination to the SB management apparatus 74. The SB management apparatus 74 performs an error process using the error detail data input from the error processing circuit 71, and transmits the error detail data to the MMB 30.

The error signal at the error level N is input to the MC interruption processing circuit 72 in addition to the error processing circuit 71. As a result, when the error level of the asserted error signal is N, the error processing circuit 71 and the MC interruption processing circuit 72 operate in parallel.

The error processing circuit 71 controls the register read/write processing circuit 73 so as to obtain data of each of the registers 51a, 51b, 61a, and 61b from the respective error processing circuits 51 and 61 of the CPU 21 and the MC 27. Then, the error processing circuit 71 specifies the output destination of the asserted error signal, and obtains error detail data from the CPU 21 when the output destination is the CPU 21. In order to negate the error signal from, for example, the output destination of the error signal, the error processing circuit 71 makes the error recording register of the error processing circuit 51 or 61, which is the output destination, store each piece of data having a value of 0 bits through the register read/write processing circuit 73.

On the other hand, the MC interruption processing circuit 72 controls the register read/write processing circuit 73 so as to obtain data of the AS factor register 62a of the AS processing circuit 62 of the MC 27, and confirms from the obtained data whether any of the AS signals has been asserted. The CPU 21 stores configuration data to be transmitted to the MMB 30 in the configuration recording register 58. When the MC interruption processing circuit 72 confirms that any of the AS signals has been asserted, then it obtains the configuration data if needed. The configuration data stored in the configuration recording register 58 is obtained in response to a request to the register read/write processing circuit 52 of the CPU 21 through the register read/write processing circuit 73, for example.

The MC interruption processing circuit 72 outputs the obtained configuration data to the SB management circuit 74, and makes the SB management circuit 74 perform an interruption process. In order to negate the AS OR signal from, for example, the MC 27, the MC interruption processing circuit 72 makes the AS factor register 62a of the AS processing circuit 62 of the MC 27 store each piece of data having a value of 0 bits through the register read/write processing circuit 73.

The SB management circuit 74 respectively performs an error process by an error notification and an interruption process by an interruption notification, and therefore it constantly transmits error detail data or configuration data to the MMB 30. Then, the BMC information processing circuit 31 of the MMB 30 processes the error detail data or the configuration data received from the BMC 26, and controls the entirety of a computer system, or issues the notification to an operator.

Described briefly is an operation of the BMC 26 in a case in which the CPU 21 is not replaced with the MC 27, i.e., a case in which the CPU 21 is mounted in the position of the MC 27.

In this case, an operation of the error processing circuit 71 may be the same as described above. However, even when the error signal at the error level N is asserted, as the CPU 21 has no AS processing circuit 62, the MC interruption processing circuit 72 cannot specify the asserted AS signal and it does not virtually operate. In a situation in which the error signal at the error level Nis asserted, either of the two CPUs 21 asserts the error signal at the error level N. Therefore, the error processing circuit 71 specifies the CPU 21 which output the asserted error signal, and outputs the error detail data obtained from the specified CPU 21 to the SB management circuit 74. As a result, the BMC 26 appropriately operates whichever of the CPU 21 and the MC 27 is mounted on the BMC 26. Accordingly, the BMC 26 may be mounted instead of the BMC 17 on the existing system board 1′ as illustrated in FIG. 2.

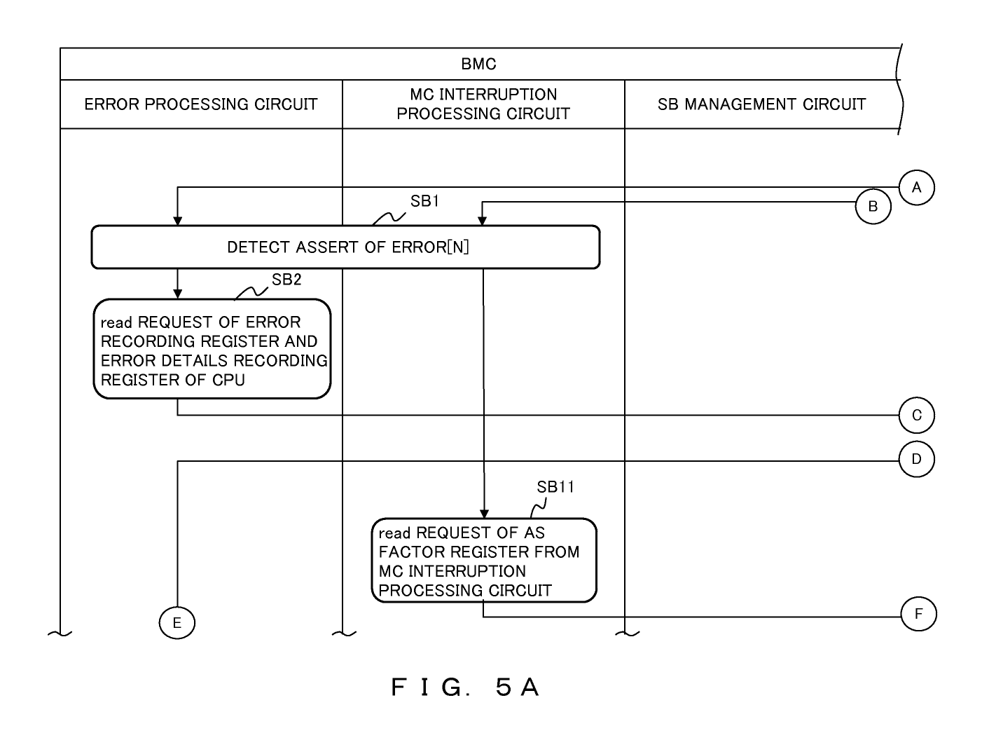

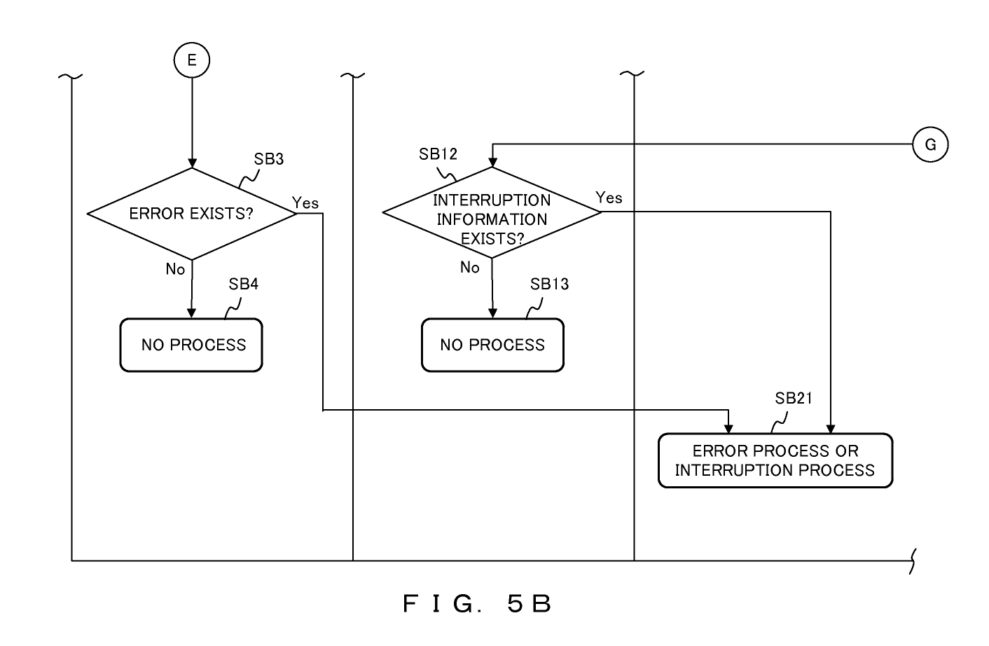

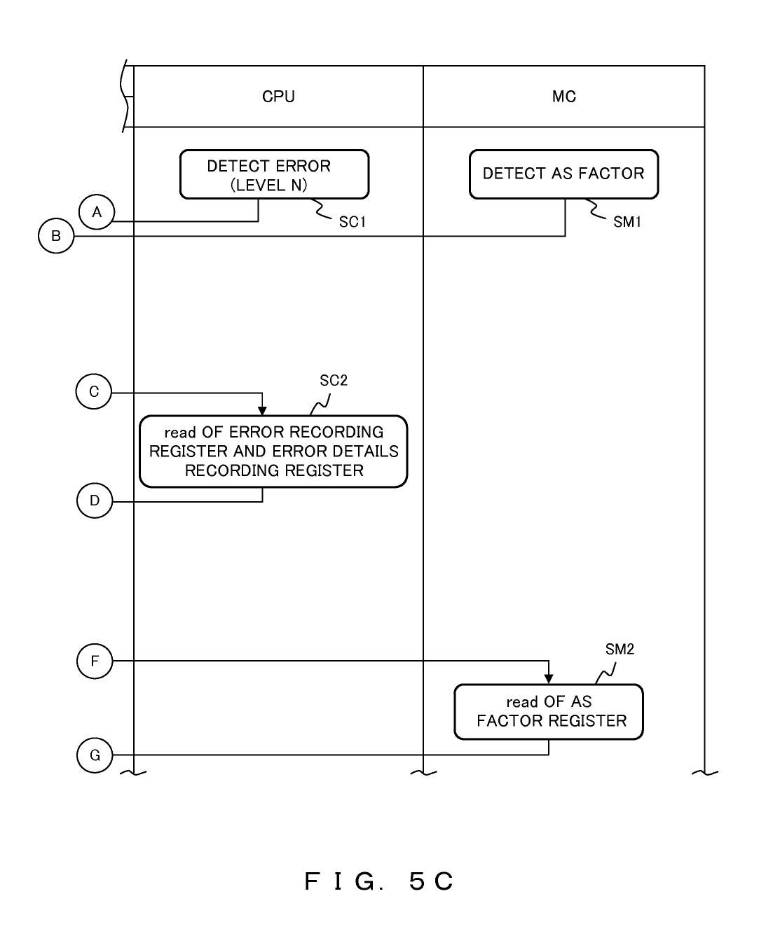

FIG. 5A to FIG. 5C are flowcharts illustrating a flow of the operations of the CPU, the MC, and the BMC. These flowcharts assume a case in which the CPU 21 or the MC 27 asserts an error signal at the error level N, and presuppose that the BMC 26 recognizes the connection of the CPU 21 and the MC 27. With reference to FIG. 5A to FIG. 5C, the operations of the CPU 21, the MC 27, and the BMC 26 are described next.

Described first is a case in which the CPU 21 asserts the error signal at the error level N.

When the CPU 21 detects an occurrence of the error at the error level N, the CPU 21 asserts the error signal at the error level N (SC1). The asserted error signal at the error level N is input to the error processing circuit 71 and the MC interruption processing circuit 72 of the BMC 26, and is detected by them (SB1). As a result, the error processing circuit 71 controls the register read/write processing circuit 73 so as to perform a read request of data from each of the registers 51a and 51b of the error processing circuit 51 of the CPU 21 (SB2). In response to the read request, the register read/write processing circuit 52 of the CPU 21 reads the data of each of the registers 51a and 51b of the error processing circuit 51, and transmits it to the BMC 26 (SC2).

The error processing circuit 71 of the BMC 26 obtains the data stored in the each of the registers 51a and 51b of the error processing circuit 51 of the CPU 21 through the register read/write processing circuit 73, and determines from the data of the register 51a whether there is an error (SB3). When the data of the register 51a indicates the existence of an error notification, the determination is “Yes”, and the error processing circuit 71 outputs error detail data, etc., which is the data of the register 51b, to the SB management circuit 74, and requests the performing of an error process. As a result, the SB management circuit 74 performs the error process in which the error detail data is transmitted to the MMB 30 (SB21). On the other hand, when the data of the register 51a does not indicate the existence of the error notification, the determination is “No”, and the error processing circuit 71 finishes a process corresponding the detected error signal at the error level N without requesting that the SB management circuit 74 perform an error process (SB4).

When the MC interruption processing circuit 72 of the BMC 26 detects the asserted error signal at the error level N, then the MC interruption processing circuit 72 of the BMC 26 controls the register read/write processing circuit 73 so as to perform a read request of data from the AS factor register 62a of the AS processing circuit 62 of the MC 27 (SB11). In response to the read request, the register read/write processing circuit 63 of the MC 27 reads the data of the AS factor register 62a of the AS processing circuit 62, and transmits the data to the BMC 26 (SM2).

The MC interruption processing circuit 72 of the BMC 26 obtains the data stored in the AS factor register 62a of the AS processing circuit 62 of the MC 27 through the register read/write processing circuit 73, and determines from the obtained data whether there is an interruption notification (SB12). When the data of the AS factor register 62a indicates the existence of the interruption notification, the determination is “Yes”, and the MC interruption processing circuit 72 outputs configuration data, etc., which the error processing circuit 71 obtained in response to the read request to the CPU 21 (SB2), to the SB management circuit 74, and requests the performing of an interruption process. As a result, the SB management circuit 74 performs the interruption process in which the configuration data is transmitted to the MMB 30 (SB21). On the other hand, when the obtained data does not indicate the existence of the interruption notification, the determination is “No”, and the MC interruption processing circuit 72 finishes a process corresponding to the detected error signal at the error level N without requesting that the SB management circuit 74 perform the interruption process (SB13).

When the CPU 21 has asserted the error signal at the error level N, the determination result in SB3 of the data obtained from the CPU 21 by the error processing circuit 71 is “Yes”, and the determination result in SB12 of the data obtained from the MC 27 by the MC interruption processing circuit 72 is “No”. As a result, the SB management circuit 74 performs the error process in SB21. Further, the error processing circuit 71 makes the error recording register 51a of the error processing circuit 51 of the CPU 21 store data in which all bit values are 0, which is not particularly illustrated.

When the MC 27 asserted the error signal at the error level N, namely, when the MC 27 asserted the AS OR signal, the error processing circuit 71 and the MC interruption processing circuit 72 perform a process similar to the process described above. However, in this case, the determination result in SB 3 of the data obtained from the CPU 21 by the error processing circuit 71 is “No”, and the determination result in SB12 of the data obtained from the MC 27 by the MC interruption processing circuit 72 is “Yes”. As a result, the SB management circuit 74 performs an interruption process in SB21. Further, the MC interruption processing circuit 72 makes the AS factor register 62a of the AS processing circuit 62 of the MC 27 store all pieces of data having a value of 0 bits, which is not particularly illustrated.

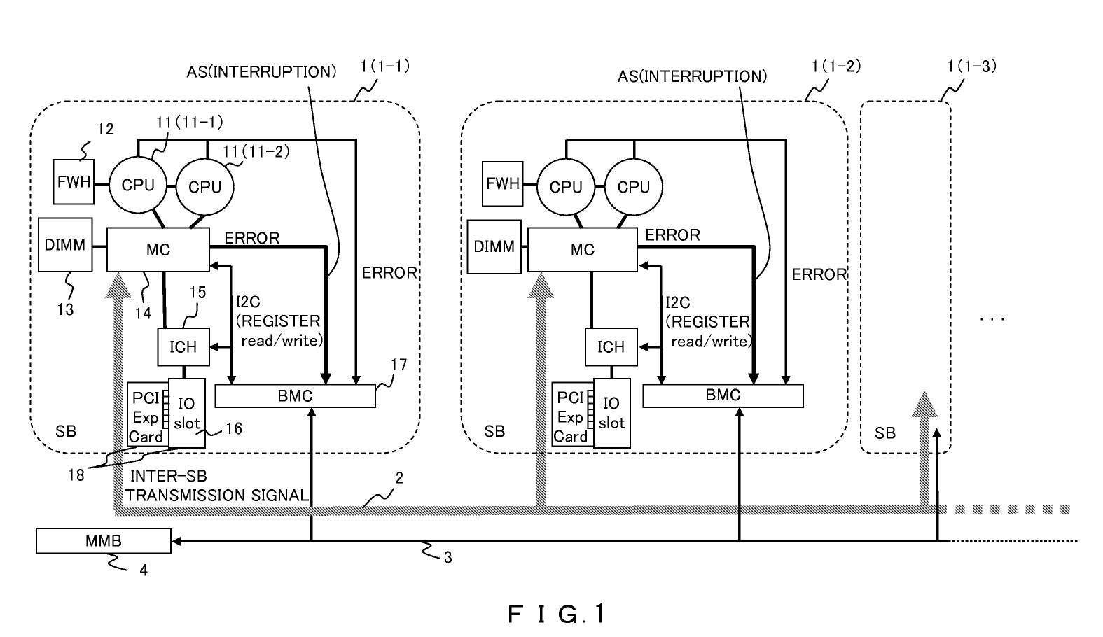

In this embodiment, a resource expansion is realized by changing the existing system board 1′ as illustrated in FIG. 2 to the system board 20 and connecting a plurality of system boards 20; however, the resource expansion is not limited to this method. The resource expansion may be realized for example by connecting the system board 1 as illustrated in FIG. 1 to the system board 20. Further, an apparatus connected for the resource expansion does not necessarily need to be a module device, such as the system board 20 or 1, but maybe a computer with a communication function (a data processing apparatus). A configuration of the system board 20 is not limited to the configuration as illustrated in FIG. 3. As an example, the system board 20 maybe an apparatus on which three or more CPUs 21 can be mounted.

A system to which the present application is applied can expand a resource using a module device without a communication function with another module device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A semiconductor apparatus, which is mounted on a data processing apparatus comprising a central processing unit, the semiconductor apparatus comprising:
a first communication unit which communicates with the central processing unit;
a second communication unit which communicates with another data processing apparatus through a slot connectable to the central processing unit; and
an interruption notification unit which notifies a management apparatus which manages the data processing apparatus of an interruption from the central processing unit.

2. The semiconductor apparatus according to claim 1, the semiconductor apparatus further comprising:
an error notification unit which notifies the management apparatus of an occurrence of an error,
wherein the interruption notification unit and the error notification unit respectively report the interruption and the error using one or more different signal lines from each other, which are allocated from among a plurality of signal lines connected to the management apparatus.

3. A management apparatus connected to a semiconductor apparatus which is mounted on a data processing apparatus comprising a central processing unit, the management apparatus comprising:
a first processing unit which inputs a first signal transmitted through any of a plurality of signal lines connected to the semiconductor apparatus, and performs a first process, the semiconductor apparatus including a first communication unit which communicates with the central processing unit, a second communication unit which communicates with another data processing apparatus through a slot connectable to the central processing unit, and an interruption notification unit which notifies a management apparatus which manages the data processing apparatus of an interruption from the central processing unit; and
a second processing unit which inputs a second signal transmitted through one or more predetermined signal lines from among the plurality of signal lines, and performs a second process.

4. The management apparatus according to claim 3, wherein:
the plurality of signal lines are connected to the central processing unit in addition to the semiconductor apparatus, and are used for the transmission of the first signal by the central processing unit;
when the first processing unit receives the signal transmitted through the one or more signal lines, the first processing unit obtains at least first data relating to the first signal from the central processing unit through another signal line different from the plurality of signal lines, and performs the first process, subject to confirmation, from the first data, of the transmission of the first signal from the central processing unit; and
when the second processing unit receives the signal transmitted through the one or more signal lines, the second processing unit obtains at least second data relating to the second signal from the semiconductor apparatus through the other signal line, and performs the second process, subject to confirmation, from the second data, of the transmission of the second signal from the semiconductor apparatus.

5. A data processing apparatus comprising:
one or more central processing units;
a semiconductor apparatus connected to the central processing unit; and
a management apparatus which manages the data processing apparatus, wherein:
the semiconductor apparatus including:
a first communication unit which communicates with the central processing unit;
a second communication unit which communicates with another data processing apparatus through a slot connectable to the central processing unit; and
an interruption notification unit which notifies the management apparatus of an interruption from the central processing unit.

6. The data processing apparatus according to claim 5, wherein:
the semiconductor apparatus includes an error notification unit which notifies the management apparatus of an occurrence of an error; and
the interruption notification unit and the error notification unit respectively report the interruption and the error using one or more different signal lines which are allocated from among a plurality of signal lines connected to the management apparatus.

7. The data processing apparatus according to claim 6, wherein:
the plurality of signal lines are connected to the central processing unit in addition to the semiconductor apparatus, and are used for a notification of the error by the central processing unit; and
the management apparatus includes:
a first processing unit which processes the notification of the error through any of the plurality of signal lines; and
a second processing unit which processes the notification of the interruption through one or more predetermined signal lines from among the plurality of signal lines.

8. The data processing apparatus according to claim 7, wherein:
the management apparatus is connected to the semiconductor apparatus and the central processing unit through another signal line which is different from the plurality of signal lines;
when the notification was issued through the one or more signal lines, the first processing unit obtains at least first data relating to the notification of the error from the central processing unit through the other signal line, and processes the notification of the error, subject to confirmation, from the first data, of the notification of the error from the central processing unit; and
when the notification was issued through the one or more signal lines, the second processing unit obtains at least second data relating to the notification of the interruption from the semiconductor apparatus, through the other signal line, and processes the notification of the interruption, subject to confirmation, from the second data, of the notification of the interruption from the semiconductor apparatus.

9. A semiconductor apparatus which transmits an error signal and an interruption signal to the outside through a connected socket, the semiconductor apparatus comprising:
a first generation unit which generates the error signal for each signal line usable for an output of the error signal;
an OR init which ORs the error signals generated by the first generation unit for the two or more signal lines;
a first output unit which outputs the OR calculated by the OR unit and the error signal which was not ORed by the OR unit to the socket through the signal line usable for the output of the error signal;
a second signal generation unit which generates the interruption signal; and
a second output unit which outputs the interruption signal generated by the second signal generation unit to the socket through one of the signal lines usable for the output of the error signal.
